(19) United States
(12) Patent Application Publication
(10) Pub. No.: US 2006/0073440 A1
(43) Pub. Date: Apr. 6, 2006

(54) Insertion shaft structure for modeling foamed material assembly

(76) Inventor: Jen-Tsu Kuo, Chang-Hua Hsien (TW)

Correspondence Address: RABIN & BERDO, P.C., Suite 500, 1101 14th Street, N.W., Washington, DC, 20005, US

(21) Appl. No.: 10/958,256

(22) Filed: Oct. 6, 2004

(51) Int. Cl. G09B 11/00

(52) U.S. Cl. 434/81

(57) ABSTRACT

An insertion shaft structure for modeling foamed material assembly which is passed through each unit of shaped foamed material, a mortise recessively formed in the left and the right sides, furthermore, wave teeth protruding along the inner wall surfaces of the mortise. Additionally, fitted in the mortise is a T-shaped peg consisting of wave teeth protruding along the two surfaces of the peg body. As such, the insertion shaft is inserted into the foamed material slot opening, enabling the enmeshment of the wave teeth of the insertion shaft and the T-shaped peg such that the T-shaped pegs are fully inserted and tightly engaged in the insertion shaft mortises and the T-shaped peg horizontal head ends are fixed in position against the periphery. As a result, the foamed material is assembled into a set shape having a strong and solid internal section that is capable of withstanding heavy pressure and force.

### BACKGROUND OF THE INVENTION

1) Field of the Invention

The invention herein relates to an insertion shaft structure for modeling foamed material assembly in which insertion shafts and T-shaped pegs are insertionally fastened through the slot openings of the foamed material, with wave teeth disposed on the insertion shafts and the T-shaped pegs enabling enmeshment such that the insertion shafts are entirely and tightly engaged, and the horizontal head ends of the T-shaped peg are fixed in position against the periphery along the outermost side of the foamed material slot openings. As such, the foamed material are assembled into a set shape having a strong and solid internal section that is capable of withstanding heavy pressure and force.

2) Description of the Prior Art

When currently marketed DIY modeling assembly objects constructed of plastic or wood components are pieced together into shape, holes are often left in the said components so insertion rods can be passed through for connection and positioning. However, as the said insertion rod are only passed through the components, a fixing means is still needed at the two sides before it is considered completely assembled; the fixing means attachment approach at the two sides of a conventional insertion rod is typically of a “threaded rotating lock” and a “tongue and groove joint” design. However, to execute a threaded rotating lock or a tongue and groove joint on wood is relatively difficult to fabricate and high in cost; the discard rate is high and, furthermore, there is breakage and other problems. With plastic, although fabrication is easier, the degree of conjoinment integrity awaits improvement because if loosening and subsequent swaying movement occurs after fabrication, when subjected to heavy pressure and force, the internal conjoinment arrangement gradually wears out and breaks. Before too long, the entire object begins to come loose and break here and there until it is finally beyond repair and completely wrecked.

Another type is the “nailing” approach. Since nails are made of metal, they gradually corrode after exposure to moisture and, furthermore, the nailing holes steadily become larger as children rock the object as a plaything for long periods, causing a repeat of the said outcome of swaying. Soon the nails are damaged and become loose such that the entire object begins to loosen, break here and there, and finally ends up as a piece of junk. At the same time, since it cannot be repetitively disassembled and assembled, there is no joy of “putting it together” nor anything amusing.

Utilizing a “glued” approach conjoins areas by adhesive bonding and, as such, although a remedy for assembly loosening, the joy of repeatedly “putting it together” is lost, which makes the object an item of avoidance to children since it lacks anything interesting. Additionally, since the glue contains chemical ingredients, the odor of which gradually spreads after a certain period, contact with the human body and the natural environment results in skin and environmental harm. At present, since the ecology of the world in the aftermath of advances in civilization faces the perplexing problem of finding a point of equilibrium, the minimization of pollution is an objective in trends to protect the earth.

### SUMMARY OF THE INVENTION

As a result, the applicant of the invention herein, following continuous observation and experimentation, successfully developed the invention herein which is submitted in application for patent rights.

The primary objective of the invention herein is to provide an insertion shaft structure for modeling foamed material assembly comprised of a versatile modeling foamed material that is formed in a plurality of assortments for set shape assembly applications in which, to accommodate insertional fastening, each unit of shaped foamed material has a penetrating, reticulated slot opening for the entry of an insertion shaft which is passed through each unit of shaped foamed material, a mortise recessively formed in both the left and the right sides and, furthermore, wave teeth protruding along the inner wall surfaces of the mortise; additionally, fitted in the mortise is a T-shaped peg consisting of wave teeth protruding along the two surfaces of the peg body; as such, after the foamed material to be assembled is sequentially arrayed and arranged together, the insertion shaft is inserted into the foamed material slot opening, following which the T-shaped peg is inserted into each of the two sides of the insertion shaft, enabling the enmeshment of the wave teeth of the insertion shaft and the T-shaped peg such that the T-shaped pegs are fully inserted and tightly engaged in the insertion shaft mortises and the T-shaped peg horizontal head ends are fixed in position against the periphery along the outermost side of the foamed material slot openings; as a result, the foamed material are assembled into a set shape having a strong and solid internal section that is capable of withstanding heavy pressure and force.

Another objective of the invention herein is to provide a an insertion shaft structure for modeling foamed material assembly in which the wave teeth of the insertion shaft and the T-shaped peg are converted into single inclination ratchet teeth.

### BRIEF DESCRIPTION OF THE DRAWINGS

FIG. 1 is an exploded drawing of the invention herein that illustrates the assembly positioning.

FIG. 2 is an isometric drawing of the invention herein after completion of assembly.

FIG. 3-A is an orthographic drawing of the invention herein after completion of assembly, as viewed from a lateral perspective.

FIG. 3-B is a cross-sectional drawing of the invention herein after completion of assembly.

FIG. 4 is an exploded drawing of another arrangement of the invention herein.

FIG. 5 is a cross-sectional drawing of another arrangement of the invention herein.

### DETAILED DESCRIPTION OF THE PREFERRED EMBODIMENTS

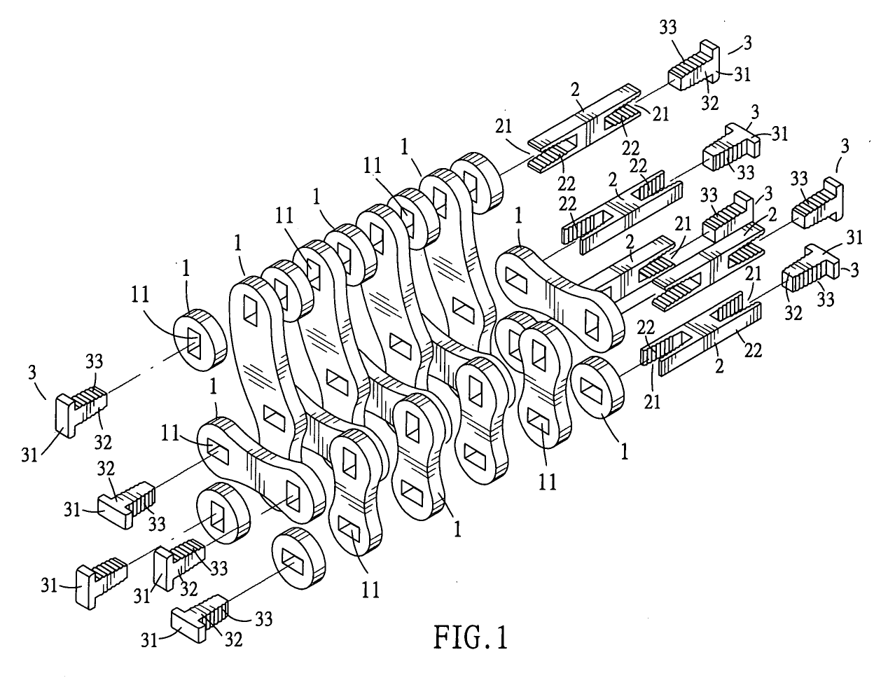

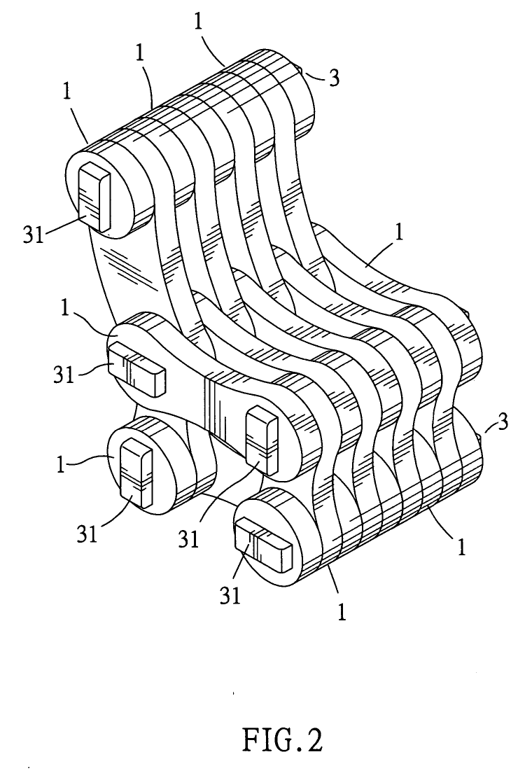

Referring to FIG. 1 and FIG. 2, the insertion shaft structure for modeling foamed material assembly of the invention herein is comprised of a versatile modeling foamed material 1 that is formed in a plurality of assortments for set shape assembly applications, such as large and small differing foamed material 1 units for building high-back reclined chairs, and has a penetrating, reticulated slot opening 11 that provides for the entry of an insertion shaft 2 which is passed through each unit of shaped foamed material 1, a mortise 21 recessively formed in both the left and the right sides and, furthermore, wave teeth 22 protruding along the inner wall surfaces of the mortise 21; additionally, fitted in the mortise 21 is a T-shaped peg 3 consisting of a horizontal head end 31, a peg body 32, and wave teeth 33 protruding along the two surfaces of the peg body 32.

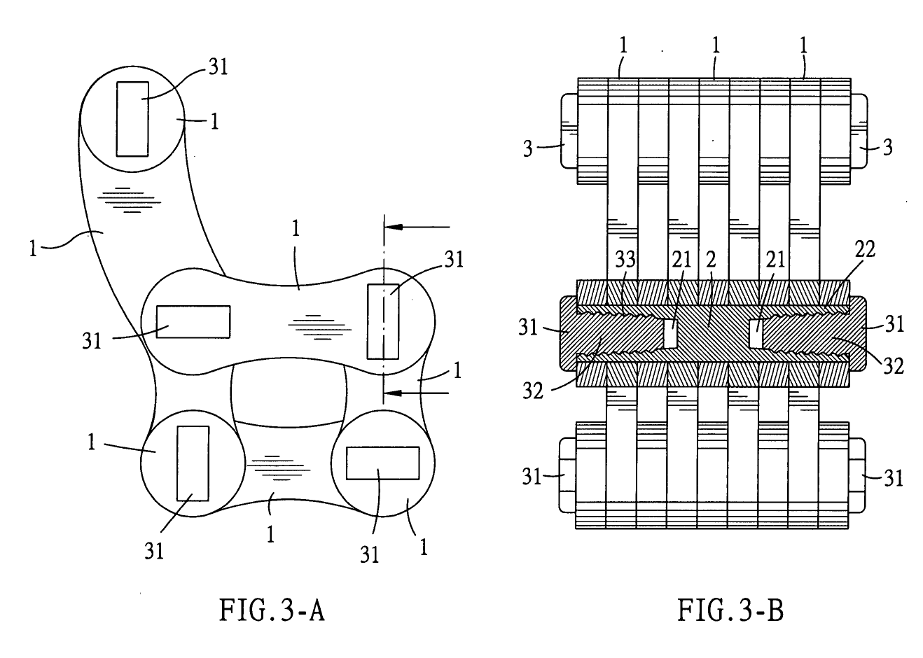

When the modeling-type foamed material 1 are assembled, after each foamed material 1 is sequentially arrayed and arranged together, the insertion shaft 2 is inserted into the foamed material 1 slot opening 11, following which a T-shaped peg 3 is inserted into each of the two sides of the insertion shaft 2, enabling the enmeshment of the wave teeth 22 and 33 of the insertion shaft 2 and the T-shaped peg 3 such that the T-shaped pegs 3 are fully inserted and tightly engaged in the insertion shaft 2 mortises 21 (as shown in FIG. 3-B), and the T-shaped peg 3 horizontal head ends 31 are fixed in position against the periphery along the outermost side of the foamed material 1 slot openings 11 (as shown in FIG. 3-A); or, the T-shaped peg 3 is first inserted into the one of the mortises 21 in the insertion shaft 2, then the sequentially arrayed foamed material 1 is arranged together, the insertion shaft 2 is placed through their slot openings 11, and finally the other T-shaped peg 3 is inserted into the remaining mortise 21 of the insertion shaft 2 to effect conjoinment. As such, the modeling foamed material 2 are assembled into a final form, wherein since the T-shaped peg 3 peg bodies 32 are fully inserted into the insertion shaft 2 mortises 21 such that the mortises 21 become tightly enslotted into a conjoined state, this constitutes a strong and solid internal section; at the same time, because of the genuinely close-fitting conjoinment, gaps that result in loosening do not occur, heavy pressure and force is withstood without separation and, furthermore, cracks that lead to breakage do not develop.

To disassemble and store, the T-shaped pegs 3 at the two sides are extricated from the insertion shaft 2 mortises 21, following which the foamed material 1 is taken apart piece by piece, segregated, and set aside for storage.

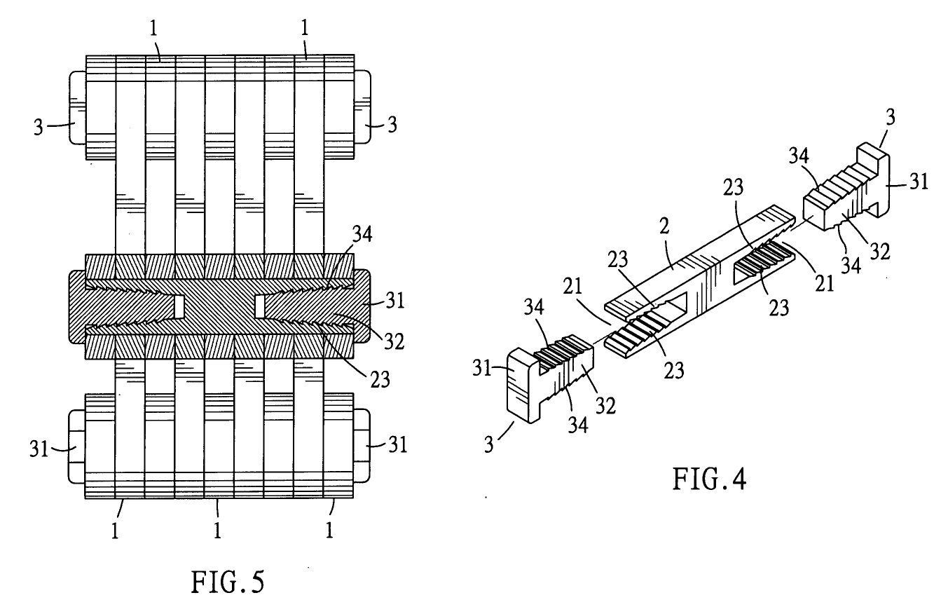

If disassembly is not desired after assembly, the wave teeth 22 and 33 of the insertion shaft 2 and the T-shaped peg 3 are converted into single inclination ratchet teeth 23 and 24 (as shown in FIG. 4 and FIG. 5); as such, dismantling is difficult following assembly and is considered a permanent state of assembly,

In summation of the foregoing section, since the invention herein is demonstrably capable of the said functions, the present invention meets patent application requirements and is submitted to the patent bureau for review and the granting of the commensurate patent rights.

1. An insertion shaft structure for modeling foamed material assembly comprised of a versatile modeling foamed material that is formed in a plurality of assortments for set shape assembly applications in which, to accommodate insertional fastening, each unit of the shaped said foamed material has a penetrating, reticulated slot opening for the entry of an insertion shaft which is passed through each unit of shaped said foamed material, a mortise recessively formed in both the left and the right sides of the said insertion shaft and, furthermore, wave teeth protruding along the inner wall surfaces of the said mortise; additionally, fitted in the said mortise is a T-shaped peg consisting of wave teeth protruding along the two surfaces of the peg body; as such, after the said foamed material to be assembled is sequentially arrayed and arranged together, the said insertion shaft is inserted into the said foamed material slot opening, following which the said T-shaped peg is inserted into each of the two sides of the said insertion shaft, enabling the enmeshment of the said wave teeth of the said insertion shaft and the said T-shaped peg such that the said T-shaped pegs are fully inserted and tightly engaged in the said insertion shaft mortises, and the said T-shaped peg horizontal head ends are fixed in position against the periphery along the outermost side of the said foamed material slot openings; as a result, the said foamed material are assembled into a set shape having a strong and solid internal section that is capable of withstanding heavy pressure and force.

2. As mentioned in claim 1 of the insertion shaft structure for modeling foamed material assembly of the invention herein, the said wave teeth of the said insertion shaft and the said T-shaped peg can be converted into single inclination ratchet teeth.
